(19) United States
(12) Patent Application Publication
(10) Pub. No.: US 2025/0305898 A1
(43) Pub. Date: Oct. 2, 2025

(54) EXPERIENCE SYSTEM

(71) Applicant: SINTOKOGIO, LTD., Nagoya-shi (JP)

(72) Inventors: Yoshikane TANAAMI, Nagoya-shi (JP); Miyuki HAYASHI, Nagoya-shi (JP)

(73) Assignee: SINTOKOGIO, LTD., Nagoya-shi (JP)

(21) Appl. No.: 19/037,378

(22) Filed: Jan. 27, 2025

(30) Foreign Application Priority Data
Mar. 28, 2024 (JP) 2024-053697

(51) Int. Cl. G01L 5/00; A63B 71/06

(52) U.S. Cl. CPC G01L 5/0052; A63B 71/0622

(57) ABSTRACT

To allow an experiencer to safely experience at least one of the power or speed of an object brought into contact with a sensor device. An experience system includes: a sensor device that includes a movable section configured to be displaced by contact with an object and that detects a force which acts on the movable section or a speed or acceleration at which the movable section is displaced; an air cannon device that emits smoke; and a controller that controls at least one of a size or speed of the smoke emitted from the air cannon device, in accordance with a detection result from the sensor device.

This Nonprovisional application claims priority under 35 U.S.C. § 119 on Patent Application No. 2024-053697 filed in Japan on Mar. 28, 2024, the entire contents of which are hereby incorporated by reference.

### TECHNICAL FIELD

The present disclosure relates to an experience system.

### BACKGROUND ART

Patent Literature 1 discloses a method for quantitatively evaluating an impact feeling from a sport hitting tool. A pressure sensor measures a force generated between a human and a sport hitting tool during swing of the sport hitting tool, and a display section displays a variation in the force measured.

### CITATION LIST

### Patent Literature

[Patent Literature 1]
Japanese Patent Application Publication Tokukai No. 2012-228351

### SUMMARY OF INVENTION

### Technical Problem

For example, an audience experiences power or speed of, for example, a blow or a throw by a professional athlete, so that the audience can feel the greatness of the professional athlete. However, in the configuration described in Patent Literature 1, the mere numerical data is displayed on the display section, and thus audiences cannot experience power or speed of, for example, a blow or a throw by professional athletes. Further, it is necessary to consider the safety of the audiences when allowing the audiences to experience the power or speed of, for example, a blow or a throw by professional athletes.

It is an object of an aspect of the present disclosure to allow an experiencer to safely experience at least one of power or speed of an object brought into contact with a sensor device.

### Solution to Problem

In order to attain the above object, an experience system in accordance with an aspect of the present disclosure includes: a sensor device that includes a movable section configured to be displaced by contact with an object and that detects a force which acts on the movable section or a speed or acceleration at which the movable section is displaced; an air cannon device that emits smoke; and a controller that controls at least one of a size or speed of the smoke emitted from the air cannon device, in accordance with a detection result from the sensor device.

### Advantageous Effects of Invention

An aspect of the present disclosure enables an experiencer to safely experience at least one of power or speed of an object brought into contact with a sensor device.

### BRIEF DESCRIPTION OF DRAWINGS

FIG. 1 is a view schematically illustrating an example of an experience system in accordance with an embodiment of the present disclosure.

FIG. 2 is a block diagram illustrating an internal configuration of a controller included in an experience system in accordance with the present disclosure.

FIG. 3 is a sequence diagram illustrating a flow of a control method carried out by an experience system in accordance with the present disclosure.

### DESCRIPTION OF EMBODIMENTS

### (Overview of Experience System 100)

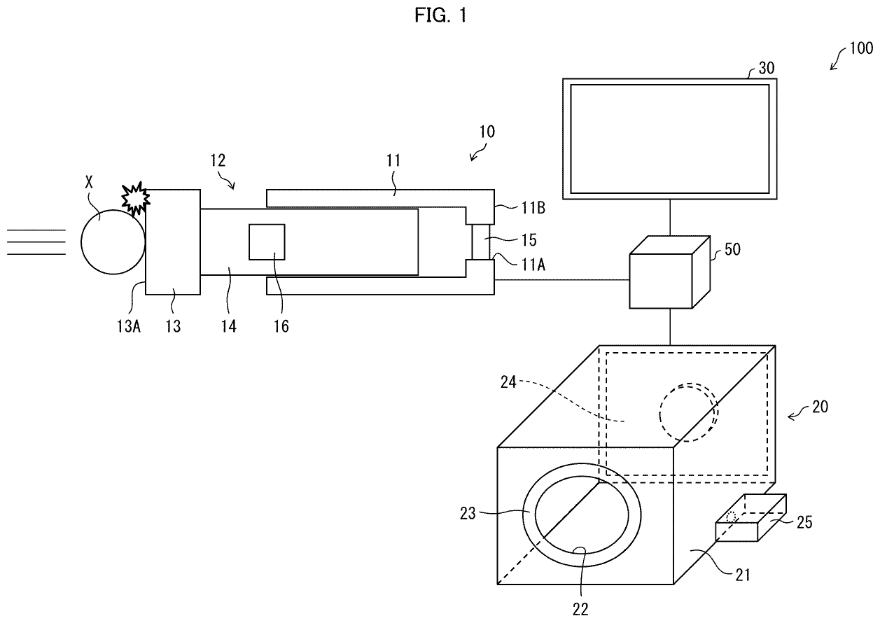

With reference to FIG. 1, the following description will discuss a schematic configuration of an experience system 100 in accordance with an embodiment of the present disclosure. FIG. 1 is a view schematically illustrating an example of an experience system 100 in accordance with an embodiment of the present disclosure.

The experience system 100 includes a sensor device 10, an air cannon device 20, and a controller 50. The experience system 100 may include a display 30. The experience system 100 replaces power of an object brought into contact with the sensor device 10 with at least one of a size or speed of smoke emitted from the air cannon device 20, so as to allow an experiencer to experience the power of the object. The experience system 100 is used, for example, in complex facility, such as sports venues in which sports are performed or in a venue in which an event is carried out.

In the following description, it is assumed that an object to be brought into contact with the sensor device 10 is a ball X. The ball X is not particularly limited, but may be, for example, a basketball, a baseball, or a soccer ball. Note that the object is not limited to a ball. The object may be, for example, a hitting tool, such as a baseball bat or a golf club. In this case, a subject may hit the sensor device 10 with the hitting tool. The object is not limited to an article such as a ball or a hitting tool, but may be, for example, an animal such as human. In the case where the object is a human, the human may bring a part of the body into the sensor device 10, e.g., hit the sensor device 10 with the hand.

The sensor device 10 includes a cylinder 11, a piston 12, a first sensor 15, and a second sensor 16. Note that sensor device 10 may include only one of the first sensor 15 or the second sensor 16.

The cylinder 11 is a member configured to have a bottomed tubular shape. In a bottom part 11B of the cylinder 11, an opening 11A for enabling entrance and exit of air between an inside and an outside of the cylinder 11 is formed. Note that the inside of the cylinder 11 may be filled with liquid.

The piston 12 is configured to be displaced by contact with an object. The piston 12 is one example of a movable section. The piston 12 is a member that reciprocates in the cylinder 11. The piston 12 reciprocates along a longitudinal direction of the cylinder 11. The piston 12 may be biased in a direction away from the bottom part 11B in the longitudinal direction of the cylinder 11. The piston 12 includes a head part 13 and a leg part 14.

The head part 13 is located outside the cylinder 11. The head part 13 has a first surface 13A to be brought into contact with the object. The first surface 13A is a surface opposite to a surface of the head part 13 which faces the cylinder 11. The leg part 14 is connected to the head part 13. The leg part 14 is accommodated so as to be movable in the cylinder 11. The leg part 14 has a diameter smaller than that of a cylindrical internal space of the cylinder 11. When the ball X is brought into contact with the first surface 13A, the piston 12 is displaced toward the bottom part 11B of the cylinder 11.

The first sensor 15 detects a force which acts on the piston 12. The first sensor 15 outputs, to the controller 50, a result of the detection of the force acting on the piston 12. The first sensor 15 is disposed in the opening 11A of the cylinder 11. Note that the first sensor 15 may be disposed on the piston 12. Examples of the first sensor 15 include a pressure sensor and a flow rate sensor.

The second sensor 16 detects a speed or acceleration of the piston 12. The second sensor 16 outputs, to the controller 50, the detected speed or acceleration of the piston 12. The second sensor 16 is disposed on the piston 12. Examples of the second sensor 16 include an acceleration sensor.

The air cannon device 20 is a device that emits smoke. The air cannon device 20 emits smoke in a size and/or at a speed corresponding to the detection result from the sensor device 10. The air cannon device 20 includes a body part 21, a diaphragm part 23, an actuator 24, and a smoke generation device 25.

The body part 21 constitutes a main part of the air cannon device 20. An accommodation space for accommodating smoke supplied from the smoke generation device 25 is formed inside the body part 21. In the body part 21, an opening 22 through which the smoke accommodated inside the body part 21 is to be emitted to an outside is formed.

The diaphragm part 23 is driven by an unillustrated driving part to change an opening diameter of the opening 22. The opening diameter of the opening 22 is changed by the diaphragm part 23, so as to change a size of the smoke emitted from the air cannon device 20. The diaphragm part 23 is driven on the basis of a control signal from the controller 50. The diaphragm part 23 may include, for example, a plurality of shutter members (not illustrated) made of metal. In this case, the plurality of shutter members are each provided so as to be movable in a radial direction of the opening 22. For example, each of the shutter members is supported by the body part 21 so as to be able to turn, and each of the shutter members is coupled to a rotating member that is rotated by a driving force from the driving section. When the rotating member rotates forward, the shutter members turn with respect to the body part 21 and move inward in a radial direction of the opening 22. Thus, the opening diameter of the opening 22 is reduced. When the rotating member rotates backward, the shutter members turn with respect to the body part 21 and move outward in a radial direction of the opening 22. Thus, the opening diameter of the opening 22 is increased.

The actuator 24 is a device for emitting, to an outside, smoke accommodated inside the body part 21. When the actuator 24 is driven, smoke is emitted from the air cannon device 20 to an outside in a clumped form. The smoke emitted from the air cannon device 20 to an outside may have a spherical shape or may have a ring shape. The actuator 24 compresses smoke accommodated inside the body part 21, and the smoke compressed by the actuator 24 is emitted to the outside of the body part 21 through the opening 22. Changing a pressure applied to the smoke by the actuator 24 changes the speed of the smoke emitted from the air cannon device 20. The actuator 24 is driven on the basis of a control signal inputted from the controller 50.

The smoke generation device 25 generates smoke and supplies the generated smoke to an inside of the body part 21. Examples of the smoke generation device 25 include a smoke generator, a smoke machine, and a fog machine. The smoke generation device 25 may generate, for example, aqueous smoke with use of a glycol-based fuming agent. The aqueous smoke is preferably odorless, nonirritant, nontoxic, or nonflammable, as the characteristics of the aqueous smoke. The smoke may be white smoke, or alternatively may be smoke in a color such as red or blue. The air cannon device 20 may not include the smoke generation device 25. In this case, the accommodation space of the body part 21 may be filled with smoke, for example, with use of dry ice or an incense.

The display 30 displays various data. The display 30 may be a display provided in complex facility such as sports venues or a venue in which an event is carried out.

The controller 50 controls the components of the experience system 100.

### (Internal Configuration of Controller 50)

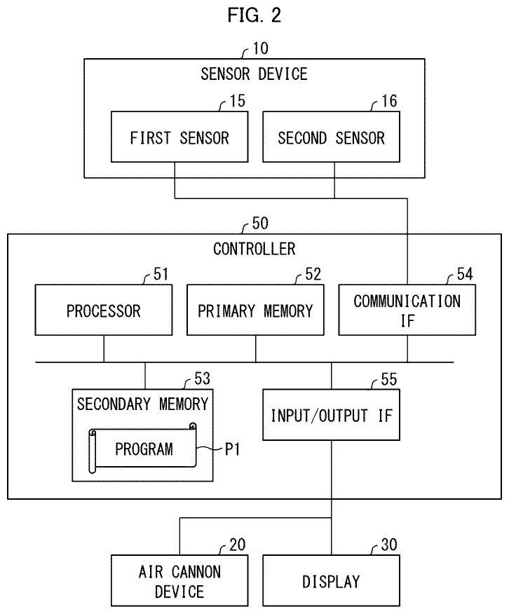

Now turning to FIG. 2, the following description will discuss an internal configuration of the controller 50 included in the experience system 100. FIG. 2 is a block diagram illustrating an internal configuration of the controller 50 included in the experience system.

The controller 50 includes a processor 51, a primary memory 52, a secondary memory 53, a communication IF 54, and an input/output IF 55. The processor 51, the primary memory 52, the secondary memory 53, the communication IF 54, and the input/output IF 55 are connected to each other via a bus.

The secondary memory 53 stores a control program P1. The processor 51 loads, on the primary memory 52, the control program P1 stored in the secondary memory 53. The processor 51 then carries out processes included in the control method M1 (described later) in accordance with instructions included in the control program P1 loaded on the primary memory 52. Examples of a device usable as the processor 51 include a central processing unit (CPU). Examples of a device usable as the primary memory 52 include a semiconductor random access memory (RAM). Examples of a device usable as the secondary memory 53 include a hard disk drive (HDD).

The control program P1 may be stored in a computer-readable non-transitory tangible storage medium. This storage medium can be the secondary memory 53 or another storage medium. For example, a tape, a disk, a card, a semiconductor memory, a programmable logic circuit, or the like can be used as said another storage medium.

The communication IF 54 is an interface for communicating with the first sensor 15 and the second sensor 16 of the sensor device 10 in a wired or wireless manner via a network. Examples of an interface usable as the communication IF 54 may include an interface for communicating with the sensor device 10 in a wired or wireless manner via the local area network (LAN).

The input/output IF 55 is an interface for connecting the air cannon device 20 and the display 30. Examples of the input/output IF 55 include the universal serial bus (USB) and the High-Definition Multimedia Interface (HDMI) (registered trademark).

### (Control Method M1 by Experience System 100)

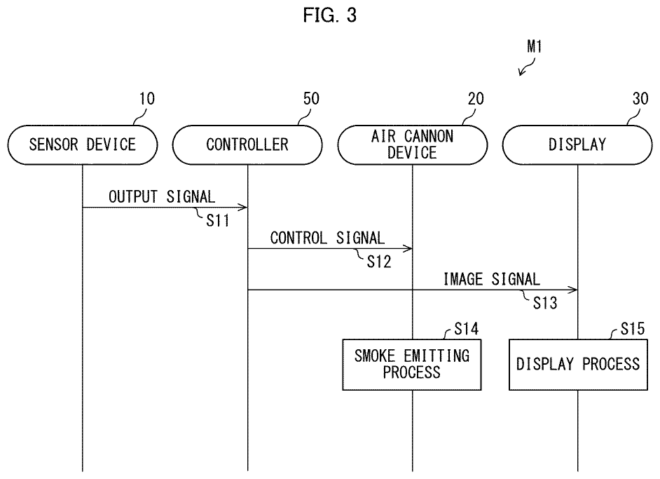

Now turning to FIG. 3, the following description will discuss the control method M1 carried out by the experience system 100. FIG. 3 is a sequence diagram illustrating a flow of the control method M1 carried out by the experience system 100.

A subject throws a ball X toward the sensor device 10. When the ball X is brought into contact with the first surface 13A of the head part 13, the piston 12 is displaced. Contact with the ball X applies force to the piston 12, and displacement of the piston 12 changes the speed or acceleration of the piston 12.

As illustrated in FIG. 3, in the step S11, the sensor device 10 outputs, to the controller 50, a result of detection of a force which acts on the piston 12 after the ball X is brought into contact with the piston 12 and/or a result of detection of the speed or acceleration at which the piston 12 is displaced after the ball X is brought into contact with the piston 12, as an output signal. More specifically, in the step S11, the first sensor 15 outputs, to the controller 50, a result of the detection of the force acting on the piston 12, as an output signal. Additionally, in the step S11, the second sensor 16 outputs, to the controller 50, a result of detection of the speed or acceleration of the piston 12, as an output signal.

In the step S12, the processor 51 outputs, via the input/output IF 55, a control signal generated on the basis of the output signals from the first sensor 15 and the second sensor 16 that have been inputted via the communication IF 54, to the air cannon device 20. The control signal includes information on at least one of a size or speed of the smoke emitted from the air cannon device 20. More specifically, the processor 51 may generate a control signal that controls the diaphragm part 23 so as to emit smoke in a size corresponding to a detection result from the first sensor 15. That is, the processor 51 generates a control signal so that smoke in a size corresponding to the power of the ball X brought into contact with the piston 12 is emitted from the air cannon device 20. Additionally, the processor 51 may generate a control signal that controls the actuator 24 so as to emit smoke at a speed corresponding to a detection result from the second sensor 16. That is, the processor 51 generates a control signal so that smoke at a speed corresponding to the speed of the ball X brought into contact with the piston 12 is emitted from the air cannon device 20.

In the step S13, the processor 51 outputs, to the display 30, a generated image signal via the input/output IF 55. In the step S13, the processor 51 generates a display screen to be displayed on the display 30, on the basis of the output signals from the first sensor 15 and the second sensor 16 that have been inputted via the communication IF 54. The screen generated includes information indicating a detection result from the sensor device 10. The processor 51 outputs information on the generated display screen to the display 30 as an image signal.

In the step S14, the air cannon device 20 emits smoke in a size and/or at a speed corresponding to the detection result from the sensor device 10, on the basis of the control signal inputted in the step S12. That is, the air cannon device 20 emits smoke in accordance with the power and/or speed of the ball X brought into contact with the piston 12. In the step S14, the air cannon device 20 drives the diaphragm part 23 to set an opening diameter of the opening 22 to a size corresponding to a detection result from the first sensor 15. In the step S14, the air cannon device 20 drives the actuator 24 to emit smoke. In this case, the air cannon device 20 drives the actuator 24 so that the speed of the smoke emitted becomes a speed corresponding to the detection result from the second sensor 16.

In the step S15, the display 30 displays the display screen generated by the controller 50 in the step S13. In the step S15, a display screen including data indicating the detection result from the first sensor 15 and/or data indicating the detection result from the second sensor 16 is displayed on the display 30. Displaying, on the display 30, a detection result(s) from the first sensor 15 and/or the second sensor 16, as described above enables an experiencer to associate at least one of a size or speed of the smoke emitted from the air cannon device 20 with information on the power or speed of the ball X actually brought into contact with the sensor device 10.

According to the experience system 100 described above, the air cannon device 20 emits smoke in a size or at a speed corresponding to a detection result from the sensor device 10. This enables an experiencer to safely experience at least one of power or speed of the ball X brought into contact with the sensor device 10.

Aspects of the present invention can also be expressed as follows:

An experience system in accordance with Aspect 1 of the present disclosure includes: a sensor device that includes a movable section configured to be displaced by contact with an object and that detects a force which acts on the movable section or a speed or acceleration at which the movable section is displaced; an air cannon device that emits smoke; and a controller that controls at least one of a size or speed of the smoke emitted from the air cannon device, in accordance with a detection result from the sensor device.

According to the experience system in accordance with Aspect 1, the air cannon device emits smoke in a size or at a speed corresponding to a detection result from the sensor device. This enables an experiencer to safely experience at least one of power or speed of the object brought into contact with the sensor device.

In an experience system in accordance with Aspect 2 of the present disclosure, in Aspect 1 above, the sensor device includes a first sensor that detects the force which acts on the movable section, and the controller controls the size of the smoke emitted from the air cannon device, in accordance with the force which acts on the movable section and which has been detected by the first sensor.

In an experience system in accordance with Aspect 3 of the present disclosure, in Aspect 1 or 2, the sensor device includes a second sensor that detects the speed or acceleration at which the movable section is displaced; and the controller controls the speed of the smoke emitted from the air cannon device, based on the speed or acceleration at which the movable section is displaced and which has been detected by the second sensor.

### SUPPLEMENTARY NOTE

The present disclosure is not limited to the embodiments above, but can be altered by a skilled person in the art within the scope of the claims. The present disclosure also encompasses, in its technical scope, any embodiment derived by combining technical means disclosed in differing embodiments as appropriate.

1. An experience system comprising:
a sensor device that includes a movable section configured to be displaced by contact with an object and that detects a force which acts on the movable section or a speed or acceleration at which the movable section is displaced;
an air cannon device that emits smoke; and
a controller that controls at least one of a size or speed of the smoke emitted from the air cannon device, in accordance with a detection result from the sensor device.

2. The experience system according to claim 1, wherein
the sensor device includes a first sensor that detects the force which acts on the movable section, and
the controller controls the size of the smoke emitted from the air cannon device, in accordance with the force which acts on the movable section and which has been detected by the first sensor.

3. The experience system according to claim 1, wherein
the sensor device includes a second sensor that detects the speed or acceleration at which the movable section is displaced; and
the controller controls the speed of the smoke emitted from the air cannon device, based on the speed or acceleration at which the movable section is displaced and which has been detected by the second sensor.
